(19) United States
(12) Patent Application Publication
(10) Pub. No.: US 2007/0248021 A1
(43) Pub. Date: Oct. 25, 2007

(54) Measurement system

(75) Inventor: Takeyoshi Suzuki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/812,706

(22) Filed: Jun. 21, 2007

Related U.S. Application Data
(62) Division of application No. 10/687,483, filed on Oct. 17, 2003.

(30) Foreign Application Priority Data
Mar. 27, 2003 (JP) 2003-087418
May 8, 2003 (JP) 2003-129777

(51) Int. Cl. H04L 1/00

(52) U.S. Cl. 370/250

(57) ABSTRACT

The objective is to realize a measurement system and measurement method enabling highly reliable communication. The present invention improves upon a measurement system comprising a setting apparatus which causes network address settings to be made in measurement instruments through a network. The measurement instruments of this system are characterized in that they comprise the following: a sending/receiving means which communicates with an external apparatus or setting means through the network; a judgment means which judges whether this sending/receiving means is communicating through a connection-oriented connection; and a setting means which performs network address settings based on the judgment results of this judgment means.

This application is a divisional of application Ser. No. 10/687,483, filed Oct. 17, 2003.

### BACKGROUND OF THE INVENTION

1. Field of the Invention

The present invention pertains to a measurement system and measurement method for controlling measurement instruments through a network, and pertains in particular to a measurement system and measurement method capable of highly reliable communication.

2. Description of the Prior Art

In recent years, with the spread of networks such as Ethernet®, measurement instruments such as paperless recorders and oscilloscopes have come to be connected to networks such as LANs (Local Area Networks) and the Internet. A protocol such as TCP/IP is often used in communication on these networks.

In addition, because the measurement instruments are connected to a network, it is necessary to set certain IP (Internet Protocol) addresses as network addresses. In many cases, IP address setting for these IP addresses is performed using a different apparatus (such as a computer). This is done in the case of paperless recorders, for example, so that there is no user interface (e.g., keyboard and display), and because entry is easier through a computer keyboard.

In addition, these measurement instruments perform measurement according to operation commands (called “commands”), which are sent from a control apparatus (such as a computer) through the network (see, for example, Japanese Laid-open Patent Application 2001-056896). These operation commands (e.g., setting measurement instrument, starting measurement, collecting data, etc.) are entered by a user into the computer through user control units, such as the computer keyboard and mouse. In addition, manufacturers of measurement instruments typically distribute software which makes it easy to enter operation commands, so users can easily operate measurement instruments through a network.

Thus, because controls such as measurement instrument IP address settings and measurement instrument operations are performed through a network, highly reliable communication is required. However, because of problems such as the following, highly reliable communication is difficult, which has been problematic.

(i) Network Address Setting

FIG. 1 is a block diagram showing an example of prior art for a case in which a network address is set.

In FIG. 1, a DHCP (Dynamic Host Configuration Protocol) server 10 is connected to a network 100, which uses a general-purpose signal line. The general-purpose signal line is, for example, Ethernet® conforming to the IEEE 802.3 standard. Measurement instruments m1 through m3 are connected to this network 100 and do not have human-machine interfaces. It should be noted that in the figure, a configuration in which three units are connected is shown for the measurement instruments m1 through m3, but any number of units may be connected.

In addition, when the measurement instruments m1 through m3 activate the system, they send an IP address setting request through the network 100 to the DHCP server 10, and the DHCP server 10 dynamically assigns IP (Internet Protocol) addresses. In addition, the measurement instruments m1 through m3 exchange data with a control computer (not shown) through the network 100.

In addition, FIG. 2 is a block diagram showing another example of prior art. Herein, items which are the same as in FIG. 1 are denoted by identical symbols and not described.

In FIG. 2, an address setting computer 20 is connected to an RS232C cable 200, which is a dedicated signal line. The measurement instrument m1 is connected to the network 100 and RS232C cable 200. In addition, the address setting computer 20 assigns a desired IP address to the measurement instrument m1 through the RS232C cable 200. It should be noted that the measurement instrument m1 exchanges data with the other measurement instruments m2 and m3 (not shown) and a computer (not shown) through the network 100.

IP address setting by a DHCP server 10 such as that shown in FIG. 1 requires that a dedicated DHCP server 10, which assigns IP address, be provided at all times. In addition, because the DHCP server 10 dynamically assigns IP addresses, it is difficult to assign and set the IP addresses desired by the user on the measurement instruments m1 through m3, which has been problematic.

In contrast, IP address setting by an address setting computer 20 such as that shown in FIG. 2 requires that an RS232C cable 200, which is a dedicated signal line, as well as a dedicated circuit for this RS232C cable 200, be provided in the measurement instrument m1, thus making the circuit complex, which has been problematic.

For this reason, there are cases where an address setting computer 20 is connected to a network 100 without using a dedicated DHCP server 10, in order to set IP addresses for each of the measurement instruments m1 through m3 (see, for example, Japanese Laid-open Patent Application 2000-269991). FIG. 3 is a diagram illustrating an example of the configuration of such an apparatus. Items which are the same as in FIGS. 1 and 2 are denoted by identical symbols and not described. In FIG. 3, the address setting computer 20 and measurement instruments m1 through m3 are connected to the network 100.

With this type of system, the address setting computer 20 stores physical addresses and so-called Ethernet® card-specific MAC (Media Access Control) addresses, which are equipment information used to individually identify each of the measurement instruments m1 through m3. The address setting computer broadcasts, as data to the measurement instruments m1 through m3, the MAC addresses of the measurement instruments m1 through m3 which are setting IP addresses with respect to the measurement instruments m1 through m3, as well as the IP addresses which are being set.

Next, if the MAC addresses in the data received by the measurement instruments m1 through m3 are the local measurement instruments m1 through m3, then the IP addresses sent as data are set as the IP addresses of the local measurement instruments m1 through m3. In addition, after the desired IP addresses are set on the measurement instruments m1 through m3, the user uses a control computer (external apparatus; not shown) to control the individual measurement instruments m1 through m3 through the network 100, performing measurements and collecting data.

Thus, because the address setting computer 20 is connected to the network 100, it is possible to assign and set the IP addresses desired by the user on the measurement instruments m1 through m3 without using a dedicated DHCP server 10 and RS232C cable 200 which is a dedicated signal line.

In addition, communication between the address setting computer 20 and the measurement instruments m1 through m3 uses a UDP-based connection using a UDP (User Datagram Protocol) port in a connectionless-oriented connection, wherein no session is established in order to perform processing rapidly. In contrast, communication between the control computer and the measurement instruments m1 through m3 is highly reliable communication which uses a TCP (Transmission Control Protocol)-based connection using a TCP port in a connection-oriented connection, wherein a session is established in order to reliably transmit important data.

“Important data” are, for example, commands which cause the measurement instruments m1 through m3 to start measurement at a prescribed timing; measurement data from the measurement results of measurements made by the measurement instruments m1 through m3; and the like.

However, even if, for example, the measurement instrument m1, among the measurement instruments m1 through m3, has engaged in a TCP connection with a control computer (not shown) and exchanged data, if it receives an IP address setting request from the address setting computer 20, it will change the IP address setting. As a result, the IP addresses before the setting change and after the setting change will differ, and the TCP connection between the measurement instrument m1 and the control computer will be forcibly disconnected and important data will be lost, which has been problematic.

Thus it is difficult to maintain highly reliable communication when network addresses are being set, which has been problematic.

(ii) Operating Measurement Instruments

In many cases, multiple measurement instruments and multiple computers are connected to a network, and a single user operates multiple measurement instruments through a single computer, or multiple users operate the same measurement instrument through their respective computers, thus increasing usability.

However, because multiple measurement instruments are connected and multiple users operate the measurement instruments, there are problems wherein, for example, an operation command is erroneously sent to a measurement instrument other than the intended measurement instrument, thereby operating it erroneously; or multiple users may operate the same measurement instrument simultaneously, making it impossible to perform the desired measurements. Furthermore, there is also a security problem, wherein a measurement instrument is illegally operated by a third party with malicious intent. Thus it is difficult to perform highly reliable communication, which has been problematic.

For this reason, in recent years, measurement systems wherein user IDs and passwords, which are identification information, are transmitted before operations are performed; measurement systems wherein the measurement instruments are provided with switches and operations are accepted from computers only when the switches are turned on; and the like have been used to prevent erroneous measurement instrument operations and ensure security (see, for example, Japanese Laid-open Patent Application 2002-156433).

However, management based on user IDs and passwords requires that user IDs and passwords be stored in and judged by measurement instruments, so they must be equipped with memory and judgment means. This increases measurement instrument size and cost. In addition, each time the number of users increases, it is necessary to add user IDs and passwords, and conversely when users are no longer active, their user IDs and passwords must be deleted. These are bothersome operations which must be performed, and managing them is also bothersome, which has been problematic.

In addition, management based on switches requires the installation of switches, thus increasing measurement instrument size and cost. In addition, each time a measurement instrument is operated, the user must turn the measurement instrument's switch on, enter the operation command through the computer's user control unit, and turn the measurement instrument's switch off. These operations have been extremely bothersome.

Thus it is difficult to perform highly reliable communication without performing bothersome operations, which has been problematic.

### SUMMARY OF THE INVENTION

The present invention has the objective of realizing a measurement system and measurement method which enable highly reliable communication.

### BRIEF DESCRIPTION OF THE DRAWINGS

FIG. 1 is a diagram which illustrates the first example configuration of a conventional measurement system for setting network addresses.

FIG. 2 is a diagram which illustrates the second example configuration of a conventional measurement system for setting network addresses.

FIG. 3 is a diagram which illustrates the third example configuration of a conventional measurement system for setting network addresses.

FIG. 4 is a block diagram which illustrates the first embodiment of the present invention.

FIG. 5 is a flowchart which illustrates an example of the operations in the apparatus shown in FIG. 4.

FIG. 6 is a block diagram which illustrates the second embodiment of the present invention.

FIG. 7 is a block diagram which illustrates the third embodiment of the present invention.

FIG. 8 is a flowchart which illustrates an example of the operations in the apparatus shown in FIG. 8.

FIG. 9 is a block diagram which illustrates the fourth embodiment of the present invention.

FIG. 10 is a block diagram which illustrates the fifth embodiment of the present invention.

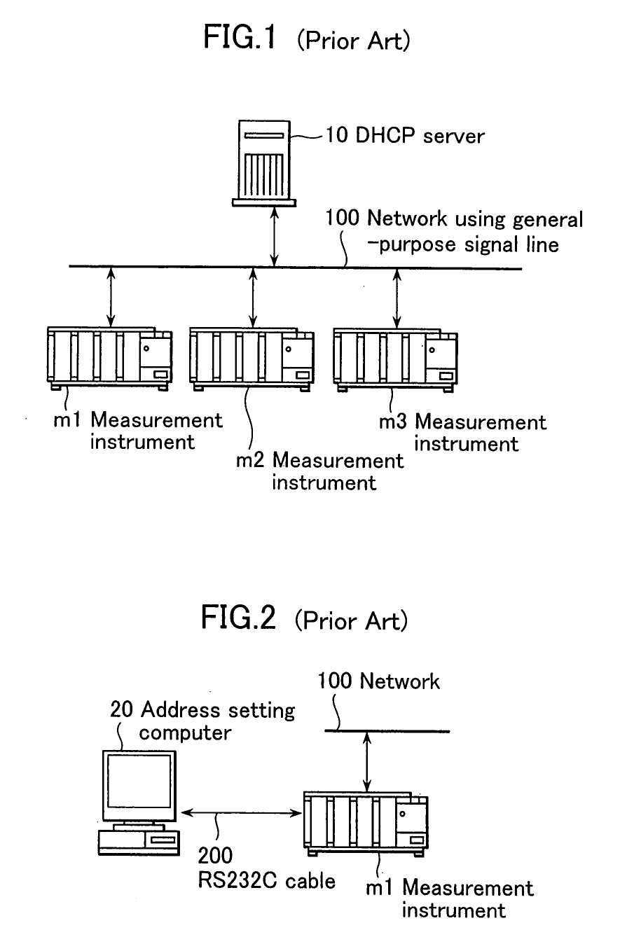

### DETAILED DESCRIPTION OF THE PREFERRED EMBODIMENTS

Embodiments of the present invention are described below using the diagrams.

(i) Network Address Setting

### First Embodiment

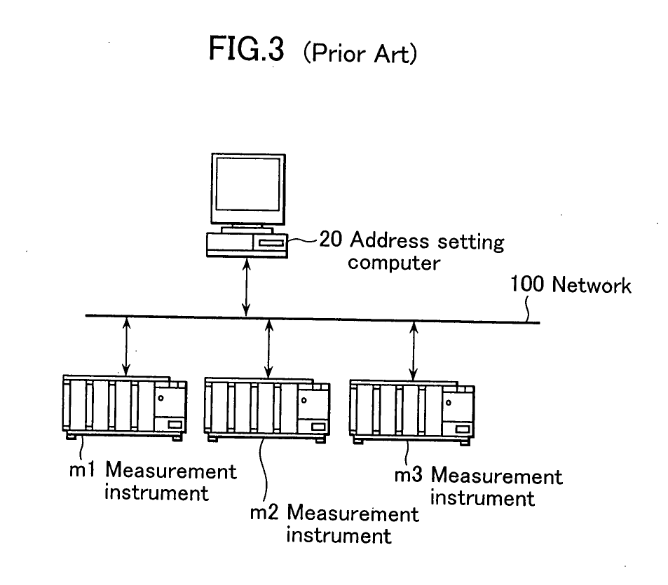

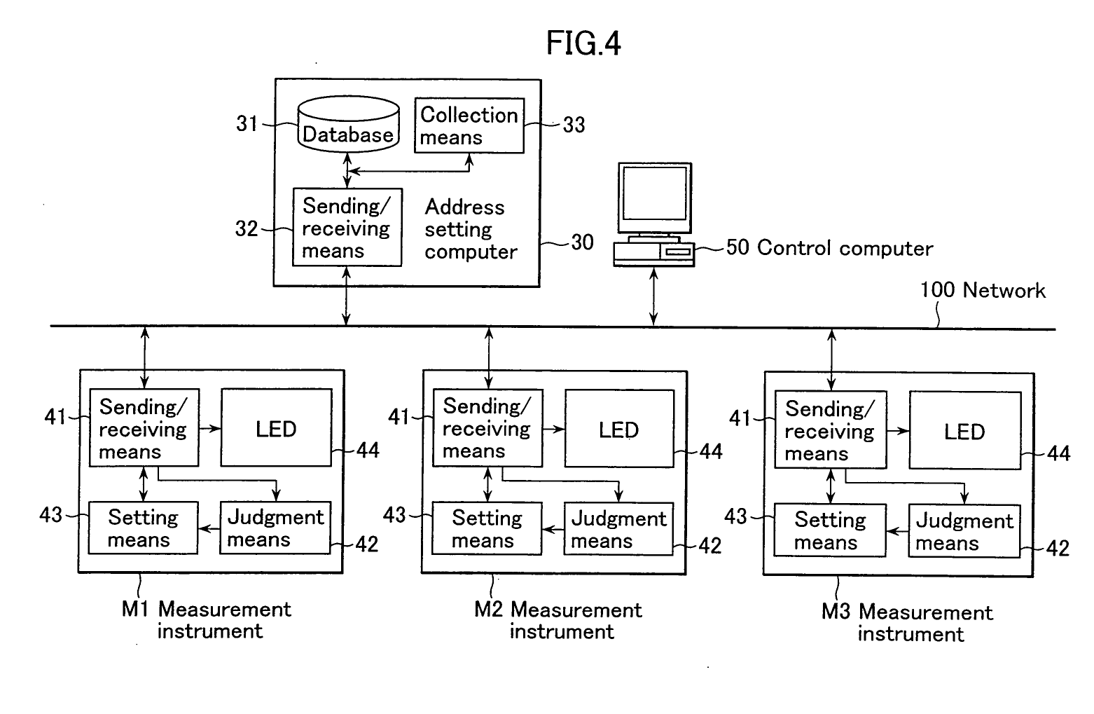

FIG. 4 is a block diagram which illustrates the first embodiment of the present invention. Herein, items which are the same as in FIG. 3 are denoted by identical symbols and not described. In FIG. 4, an address setting computer 30 is provided instead of the address setting computer 20, and measurement instruments M1 through M3 are provided instead of measurement instruments m1 through m3. In addition, a control computer 50 is newly provided.

The address setting computer 30 is a setting apparatus which is connected to the network 100 and comprises a database 31, sending/receiving means 32, and collection means 33. The database 31 is an equipment information storage means which stores equipment information, such as MAC addresses, on measurement instruments M1 through M3. The sending/receiving means 32, which comprises at least a UDP port, is connected to the network 100, and communicates with the measurement instruments M1 through M3. In addition, the sending/receiving means 32 reads the MAC address which is to be set from the database 31. The collection means 33 causes the sending/receiving means 32 to collect MAC addresses and IP addresses, and it stores the MAC addresses and IP addresses from the sending/receiving means 32 in the database 31.

The measurement instruments M1 through M3 are connected to the network 100 and comprise sending/receiving means 41, judgment means 42, setting means 43, and LEDs 44. It should be noted that the measurement instruments M1 through M3, like the measurement instruments m1 through m3, do not have human-machine interfaces such as keyboards and displays for setting IP addresses.

The sending/receiving means 41 comprises a UDP port and TCP port, and is connected to the network 100. The judgment means 42 judges whether the sending/receiving means 41 has established a TCP connection using the TCP port. The setting means 43 sets the network address received by the sending/receiving means 41 based on the judgment results of the judgment means 42. The LED 44 is a display means which turns on and off according to instructions from the sending/receiving means 41.

The control computer 50 is an external apparatus which is connected to the network 100 and communicates with the measurement instruments M1 through M3 through TCP connection.

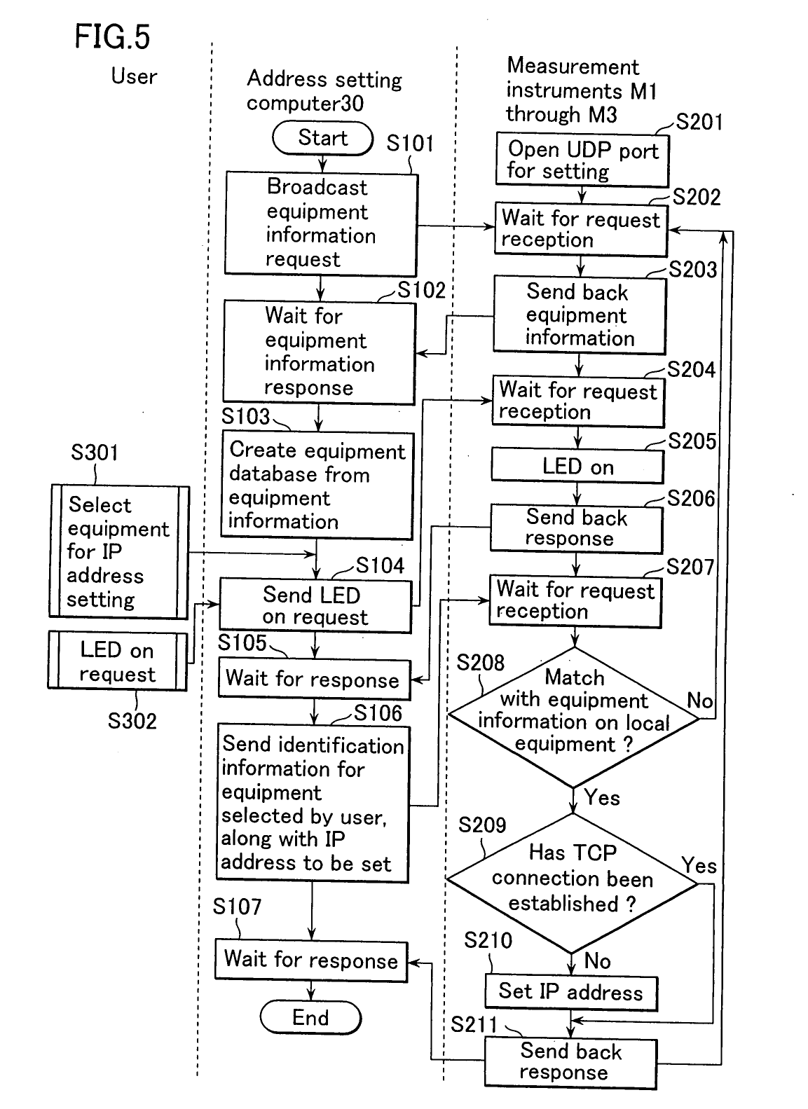

The operations of such an apparatus will be described using FIG. 5. FIG. 5 is a flowchart which illustrates an example of the operations in the apparatus shown in FIG. 4.

The collection means 33 broadcasts a MAC address send request to the measurement instruments M1 through M3 through a UDP connection using the UDP port of the sending/receiving means 32 (S101) and waits for a response (S102).

For their part, the sending/receiving means 41 of the measurement instruments M1 through M3 open their UDP ports (S201) and wait for a request from the address setting computer 30. Next, when a MAC address send request is received from the address setting computer 30, each of the sending/receiving means 41 of the measurement instruments M1 through M3 sends back its own MAC address to the address setting computer 30 (S203), and after sending it back, waits for the next request (S204).

Again returning to the address setting computer 30, the collection means 33 stores, in the database 31, the MAC addresses of the individual measurement instruments M1 through M3 collected via the sending/receiving means 32, as well as the IP addresses contained in the packet headers, and furthermore creates a list of the MAC addresses and IP addresses of the measurement instruments M1 through M3 connected to the network 100 and displays the list of measurement instruments M1 through M3 on a display unit (not shown) (S103).

The user uses a user control unit (such as a keyboard or mouse; not shown) to select from this list the measurement instruments M1 through M3 desired for IP address setting, and furthermore enters the IP address which is to be set (S301). In addition, the user requests the LED 44 to turn on through the user control unit (S302).

This LED 44 ON request causes the sending/receiving means 32 to read, from the database 31, the MAC addresses of the measurement instruments M1 through M3 selected using the user control unit, and send an ON request and MAC address through the UDP port by broadcasting (S104). It then waits for a response from the selected measurement instruments M1 through M3 (S105).

Next, if the MAC address in the received data is locally addressed, the sending/receiving means 41 of the measurement instruments M1 through M3 turns on the LED 44 for several seconds (S205), sends a response to the LED 44 ON request back to the address setting computer 30 (S206), and after sending it back, waits for the next request (S207).

Again returning to the address setting computer 30, when the sending/receiving means 32 receives a response from the measurement instruments M1 through M3, it sends, by broadcasting through the UDP port, data consisting of the MAC address of the measurement instruments M1 through M3 selected through the user control unit grouped with the IP address desired for setting which has been entered through the user control unit (S106), then waits for a response from the selected measurement instruments M1 through M3 (S107).

Next, if the MAC address in the received grouped data is not locally addressed, the sending/receiving means 41 of the measurement instruments M1 through M3 waits for a request from the address setting computer 30 (S208, S202).

If the MAC address in the received grouped data is locally addressed, the IP address in the received data is output to the setting means 43, and the judgment means 42 checks the TCP connection of the sending/receiving means 41. More specifically, the judgment means 42 judges whether the sending/receiving means 41 of the measurement instruments M1 through M3 has established a TCP connection with the control computer 50 using the TCP port. It should be noted that it is preferable for the judgment means 42 to check the TCP connection at all times (S208, S209).

Next, if a TCP connection has been established with the control computer 50 based on the judgment results of the judgment means 42, the setting means 43 causes the sending/receiving means 41 to send back an error without setting the received IP address (S209, S211). If a TCP connection has not been established, the setting means 43 sets the received IP address in the local measurement instruments M1 through M3 (S209, S210) and sends a response to the sending/receiving means 41 indicating that the setting was successful (S211). Next, when the sending/receiving means 41 sends back an error or success, it waits for a request from the address setting computer 30 (S202).

Thus, if the IP address setting request from the address setting computer 30 is addressed to the local measurement instruments M1 through M3, the setting means 43 sets the IP address based on the judgment results of the judgment means 42. More specifically, when the sending/receiving means 41 has established a TCP connection with the control computer 50, the setting means 43 sets the IP address, so the IP addresses of the TCP-connected measurement instruments M1 through M3 are not changed. Accordingly, the TCP connection between the measurement instruments M1 through M3 and the control computer 50 is never disconnected. Therefore, it is possible to change IP addresses while maintaining highly reliable communication.

In addition, the collection means 33 causes the sending/receiving means 32 to collect the MAC addresses of the measurement instruments M1 through M3 connected to the network 100, so it is possible to check the most recent connection statuses for the network to which the measurement instruments M1 through M3 are connected. Accordingly, it is possible to reliably manage and set network addresses.

More specifically, when the measurement subject of the measurement instruments M1 through M3 changes, a new measurement instrument is installed or conversely, removed. However, because the collection means 33 causes the sending/receiving means 32 to collect the MAC addresses of the measurement instruments M1 through M3 connected to the network 100, it is possible to check the most recent connection statuses for the network to which the measurement instruments M1 through M3 are connected. Accordingly, it is possible to reliably manage and set IP addresses.

Furthermore, because the sending/receiving means 41 causes the LED 44 to turn on when the MAC address in the data received from the address setting computer 30 is locally addressed, it is possible for the user to visually check the measurement instruments M1 through M3 being set, even if multiple measurement instruments M1 through M3 are connected to the network 100. Accordingly, the user can prevent IP addresses from being set on the wrong subject.

### Second Embodiment

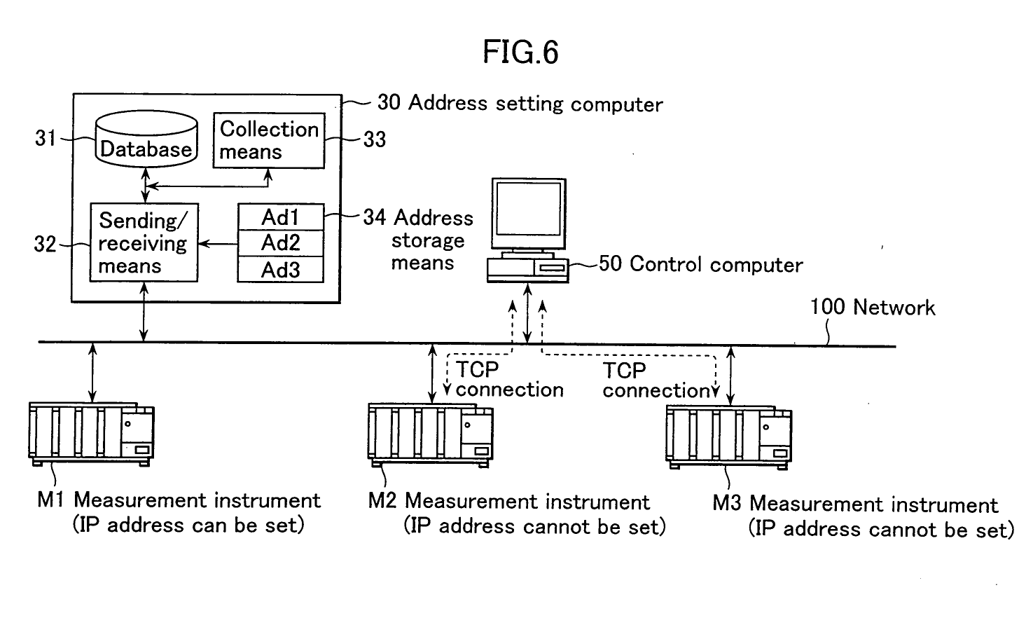

FIG. 6 is a block diagram which illustrates the second embodiment of the present invention. Herein, items which are the same as in FIG. 4 are denoted by identical symbols and not described. In addition, the sending/receiving means 41, judgment means 42, setting means 43, and LED 44 of the measurement instruments M1 through M3 are not illustrated.

In FIG. 6, an address storage means 34 is newly added to the address setting computer 30. The address storage means 34 stores the IP addresses assigned to the measurement instruments M1 through M3 and outputs the IP addresses to the sending/receiving means 32.

The operations of such an apparatus will now be described.

In step S301 of the flowchart shown in FIG. 5, the user sets, in the address storage means 34 using a user control unit (not shown), the IP addresses to be assigned to the measurement instruments M1 through M3, such as Ad1, Ad2, and Ad3. Thereafter, the sending/receiving means 32 sequentially reads the IP address Ad1 starting at the beginning of the address storage means 34, and performs the operations of steps S104 through S107 and S204 through S211 with respect to the measurement instrument M1 corresponding to this IP address. Thereafter, in the same manner, the sending/receiving means 32 reads the IP addresses Ad2 and Ad3 of the address storage means 34, and repeats the operations of steps S104 through S107 and S204 through S211 with respect to the measurement instruments M2 and M3.

For example, an IP address is set with respect to the measurement instrument M1, which is not in a TCP connection with the control computer 50, while IP addresses are not set with respect to measurement instruments M2 and M3, which are communicating through TCP connections.

Thus, the address storage means 34 stores the IP addresses desired for setting with respect to the measurement instruments M1 through M3, and the address storage means 34 sends, to the measurement instruments M1 through M3, all of the IP addresses stored in the address storage means 34. Therefore, the user does not need to select the measurement instruments M1 through M3 one unit at a time through the user control unit (not shown) and set the IP addresses. Accordingly, it is possible to rapidly set the IP addresses on the measurement instruments M1 through M3.

It should be noted that the present invention is not limited to this, and may be as follows.

(i-1) In the apparatuses shown in FIGS. 4 and 6, configurations were presented wherein three measurement instruments M1 through M3 are connected to the network 100, but this may be any number of units.

(i-2) In the apparatuses shown in FIGS. 4 and 6, configurations were presented wherein the address setting computer 30 causes the IP addresses to be set on the measurement instruments M1 through M3, while the control computer 50 causes the measurement instruments M1 through M3 to perform measurements and collect data. However, it is also permissible for the address setting computer 30 to cause the measurement instruments M1 through M3 to perform measurements and collect data. More specifically, it is permissible for the same computer to handle both address setting and controls. In this case, the sending/receiving means 32 comprises a TCP port, and uses a TCP connection to communicate measurement instructions and data collection to the measurement instruments M1 through M3. Of course, a UDP communication is used for communication in cases where IP address setting is caused to be performed.

(i-3) In the apparatuses shown in FIGS. 4 and 6, configurations were presented wherein the sending/receiving means 41 causes the LED 44 to turn on if the MAC address in the data received from the address setting computer 30 is locally addressed. However, it is also permissible to not provide an LED 44, which is a display means. In this case, in the flowchart shown in FIG. 5, the address setting computer 30 does not need to make an LED ON request (S104) or wait for a response (S105); it sends data consisting of the IP address grouped with the MAC address to the equipment selected by the user. Of course, the measurement instruments M1 through M3 do not turn on the LED (S205) or send a response (S206).

(i-4) In the apparatuses shown in FIGS. 4 and 6, configurations were presented wherein the address setting computer 30 waits for an IP address setting response (S107) and ends the process. However, if the response from the measurement instruments M1 through M3 (S211) is an error, it is permissible to again send data consisting of the IP address and MAC address after a fixed length of time passes (S106).

(i-5) In the apparatuses shown in FIGS. 4 and 6, configurations were presented wherein an LED 44 is used as the display means. However, it is also permissible to use a 7-segment display LED unit using multiple LEDs. In this case, it is permissible for the address setting computer 30 to cause the LED unit to display the number of times an error response is received from the measurement instruments M1 through M3 and IP address setting is retried.

(i-6) In the apparatuses shown in FIGS. 4 and 6, configurations were presented wherein the collection means 33 causes the sending/receiving means 32 to collect the MAC addresses of the measurement instruments M1 through M3 connected to the network 100 and stores them in the database 31. However, it is also permissible to not provide a collection means 33 in cases where there are no changes in the measurement instruments M1 through M3 connected to the network 100.

(i-7) In the apparatuses shown in FIGS. 4 and 6, configurations were presented wherein MAC addresses are used as equipment information for identifying the measurement instruments M1 through M3. However, it is also permissible to use equipment numbers which are assigned in advance separately to each of the measurement instruments M1 through M3, stored in the nonvolatile memories of the individual measurement instruments M1 through M3, or set using DIP switches provided inside the housing. These equipment numbers are set independently by the manufacturers of the measurement instruments M1 through M3. The equipment numbers are set without redundancy.

(ii) Operating Measurement Instruments

### Third Embodiment

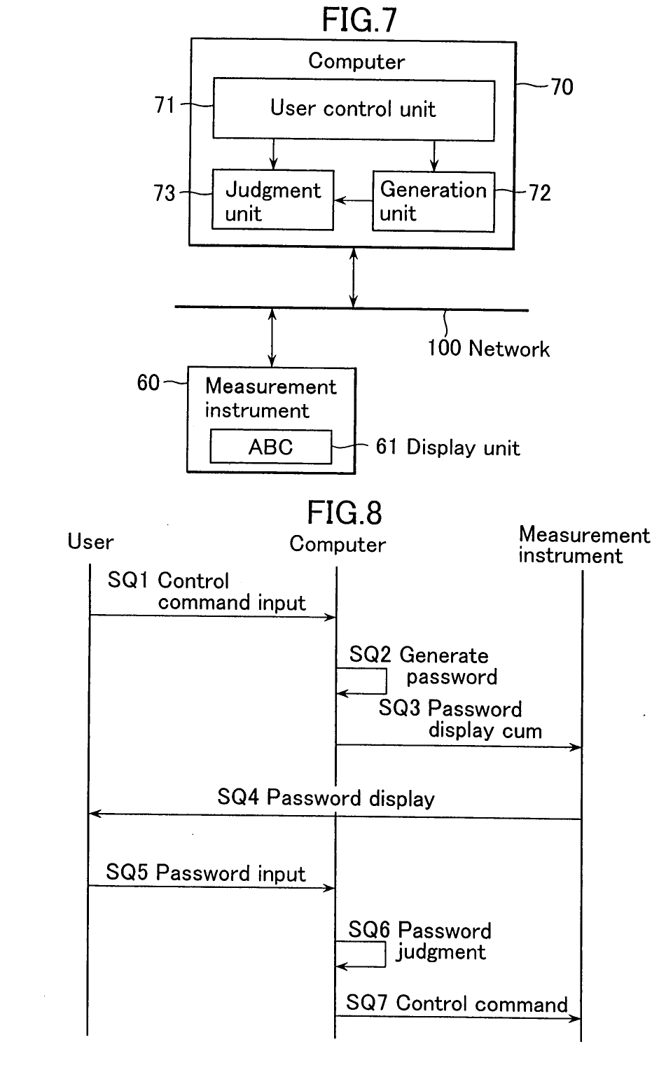

FIG. 7 is a block diagram which illustrates the third embodiment of the present invention. In FIG. 7, the network 100 is an Ethernet® as in FIGS. 4 and 6, and is connected to the Internet, a LAN (Local Area Network), or the like.

A measurement instrument 60 is, for example, a paperless recorder, oscilloscope or the like, which is connected to the network 100 and comprises a display unit 61. The display unit 61 is, for example, a liquid crystal display, multiple LEDs or the like, and displays letters, numbers, and the like.

The computer 70 is a control apparatus which is connected to the network 100, and sends operation commands to the measurement instrument 60 to operate it. In addition, the computer 70 comprises a user control unit 71, password generation unit 72, and judgment means 73. The user control unit 71 is, for example, a keyboard, mouse or the like, into which operation commands and passwords are entered. The password generation unit 72 generates a password each time an operation command is entered in the user control unit 71. The judgment means 73 judges whether the password entered in the user control unit 71 matches the password from the password generation unit 72. If they match, it sends the operation command entered in the user control unit 71 through the network 100 to the measurement instrument 60.

The operations of such an apparatus will now be described.

FIG. 8 is a diagram which illustrates an example of the operations in the system shown in FIG. 7.

The user enters an operation command (e.g., setting measurement instrument, starting measurement, collecting data, etc.) into the user control unit 71 (SQ1). When an operation command is entered into this user control unit 71, the password generation unit 72 generates a password (e.g., ABC) in which numbers and letters are randomly combined) and outputs it to the judgment means 73 (SQ2), and also sends, to the measurement instrument 60, a display command to display this password “ABC” (SQ3). Next, the measurement instrument 60 displays the password “ABC” on the display unit 61 in accordance with the display command from the computer 70. Furthermore, the user visually checks the password “ABC” displayed on the display unit 61 and enters the password “ABC” in the user control unit 71 (SQ5).

The judgment means 73 judges whether the password “ABC” entered in this user control unit 71 matches the password “ABC” from the password generation unit 72. At this time, it is preferable for the judgment means 73 to perform judgment only in cases where the password “ABC” is entered through the user control unit 71 during the validity period of the password “ABC” from the password generation unit 72. The validity period is the period starting when the password “ABC” is entered from the password generation unit 72 in SQ2; it varies depending on the environment and status of the measurement instrument 60, but is preferably the minimum time required for the user to enter the password “ABC”. For example, if the measurement instrument 60 and computer 70 are installed next to each other, this may be approximately one minute; if they are installed away from each other, then it should be set to the time required for the user to move, visually check the display unit 61, return, and enter the password “ABC” (SQ6).

If they match, then the judgment means 73 sends, to the measurement instrument 60, the operation command entered in the user control unit 71 (SQ7). Accordingly, the measurement instrument 60 operates in accordance with the operation command. Of course, if they do not match, the judgment means 73 does not send the operation command to the measurement instrument 60.

Thus, when the operation command is entered in the user control unit 71, the password generation unit 72 generates the password “ABC” and the password “ABC” is displayed on the display unit 61 of the measurement instrument 60. Next, if the password “ABC” from the password generation unit 72 matches the password “ABC” from the user control unit 71, then the judgment means 73 sends it to the measurement instrument 60. Therefore, it is not necessary to cause the measurement instrument 60 to check user IDs or passwords, or to provide a switch in the measurement instrument 60. Accordingly, security is high and erroneous operations are reduced with simple operations. Therefore, it is possible to perform highly reliable communication even though complex operations are not performed. Furthermore, it is not necessary to provide a switch or memory in the measurement instrument 60, making it possible to reduce size and cost.

Thus, because the password “ABC” is entered after a visual check of the display unit 61 of the measurement instrument 60 being operated, it is possible to prevent erroneous operation of the wrong measurement instrument 60, as well as illegal operation by a third party with malicious intent.

Furthermore, security can be increased because the judgment means 73 checks whether the password “ABC” matches within a validity period. This is useful, for example, in cases where the user may move away from the front of the user control unit 71 after entering an operation command in the user control unit 71.

### Fourth Embodiment

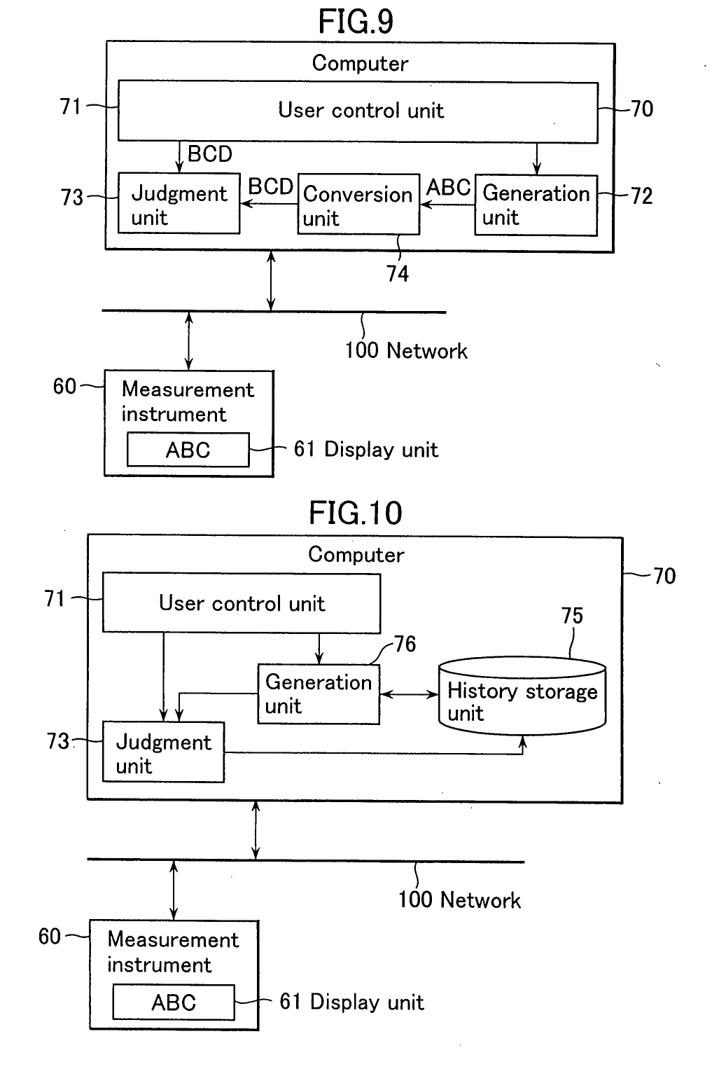

FIG. 9 is a block diagram which illustrates the fourth embodiment of the present invention. Herein, items which are the same as in FIG. 7 are denoted by identical symbols and not described. In FIG. 9, a conversion unit 74 is newly provided between the password generation unit 72 and judgment means 73. The conversion unit 74 converts the password generated by the password generation unit 72 according to prescribed rules and outputs it to the judgment means 73. It should be noted that “prescribed rules”, in the case of alphabetical letters, for example, convert each letter to its immediately subsequent letter (“BCD” if “ABC”; “YZA” if “XYZ”); and in the case of numbers add “1” to each digit of the number (“246” if “135”; “890” if “789”).

The operations of such an apparatus will now be described.

With such an apparatus, the operations are nearly the same as those of the apparatus shown in FIG. 7. The difference in operations is that the conversion unit 74 converts the password “ABC” from the password generation unit 72 according to prescribed rules, and outputs the converted password “BCD” to the judgment means 73. Of course, the display unit 61 displays the unconverted password “ABC” from the password generation unit 72.

Next, the user visually checks the password “ABC” displayed on the display unit 61 and enters the password “BCD” through the user control unit 71. Accordingly, the judgment means 73 judges whether the password “BCD” entered in the user control unit 71 matches the converted password “BCD” from the conversion unit 74.

Thus the conversion unit 74 converts the password “ABC” to “BCD” and the judgment means 73 judges whether the converted password “BCD” matches the password “BCD” from the user control unit 71. For this reason, it is possible only for users knowing this conversion rule to operate the measurement instrument 60. Accordingly, it is possible to increase security. Therefore, it is possible to perform more highly reliable communication.

### Fifth Embodiment

FIG. 10 is a block diagram which illustrates the fifth embodiment of the present invention. Herein, items which are the same as in FIG. 7 are denoted by identical symbols and not described. In FIG. 10, a history storage unit 75 is newly provided in the computer 70. The history storage unit 75 holds the history of operation commands sent by the judgment means 73 to the measurement instrument 60. In addition, a password generation unit 76 is provided instead of the password generation unit 72. When an operation command is input to the user control unit 71, the password generation unit 76 generates a password based on the history stored in the history storage unit 75.

The operations of such an apparatus will now be described.

With such an apparatus, the operations are nearly the same as those of the apparatus shown in FIG. 7. The difference in operations is that when an operation command is input to the user control unit 71, the password generation unit 76 reads the history stored in the history storage unit 75, checking how many times up until now the operation command entered in the user control unit 71 has been executed. For example, in the case of an operation command which causes the time and date at which the user started using the measurement instrument 60 to be set, if it has been executed even once, the password generation unit 76 will not generate a password. Another operation command generates the password “ABC” in the same manner as the apparatus shown in FIG. 7. For its part, the history storage unit 75 monitors the transmitted commands sent from the judgment means 73 to the measurement instrument 60 and stores the history.

Thus, when an operation command is input to the user control unit 71, the password generation unit 76 generates a password based on the history stored in the history storage unit 75, so it is possible to restrict the number of times an operation command can be executed. Accordingly, it is possible to prevent changes to the measurement instrument 60 settings, and to increase the reliability of information set in the measurement instrument 60.

It should be noted that the present invention is not limited to this, and may be as follows.

(ii-1) In the apparatuses shown in FIGS. 7, 9, and 10, configurations were presented wherein a single measurement instrument 60 is connected to the network 100, but any number of measurement instruments 60 may be connected, and the computer 70 may control and operate multiple measurement instruments 60. In addition, any number of computers 70 may be connected to the network 100, and they may control and operate a measurement instrument 60 through sharing.

(ii-2) In the apparatuses shown in FIGS. 7, 9, and 10, configurations were presented wherein the judgment means 73 judges whether the passwords match within a validity period, but it is also permissible to not prescribe a validity period.

(ii-3) In the apparatuses shown in FIGS. 7, 9, and 10, it is preferable that the period during which the display unit 61 displays the password “ABC” be the password “ABC” validity period at the longest. It is preferable that it be set as the minimum time required for the user to view the password “ABC”, although this varies depending on the environment and status of the measurement instrument 60. For example:
(a) If the measurement instrument 60 and computer 70 are installed next to each other, it is preferable to set the display period to approximately 10 seconds, and the validity period to approximately one minute.
(b) If the measurement instrument 60 and computer 70 are located in different rooms or buildings, it is preferable to set the display period as the movement time during which the user moves and visually checks the display unit 61; and the validity period as the time consisting of the round-trip time for the user to move, visually check the display unit 61, and return, plus the time required to enter the password.
(c) If multiple measurement instruments 60 installed in a factory are to be operated at the same time, it is preferable to set the display period as the time required to go around once to the multiple measurement instruments 60 installed in the factory; and the validity period as the time required to go around the factory once, and the time required to enter the password.

Thus, because the display period is set as the password validity period or less, the display unit 61 never displays the password at unnecessary times, so security can be increased. Therefore, it is possible to perform communication with even higher reliability. This is useful, for example, in cases where the user may move away from the front of the user control unit 71 after entering an operation command in the user control unit 71. It should be noted that this display period is set in advance by the user through the user control unit 71 or a user control unit (not shown) on the measurement instrument 60.

In addition, in cases (b) and (c), there is a possibility that a third party could view the password before the user reaches the measurement instrument 60, so it is preferable to provide, in the computer 70, a timing adjustment unit, which adjusts the timing for sending, to the measurement instrument 60, the passwords “ABC” generated by the password generation units 72 and 76. In addition, it is preferable for this timing adjustment unit to send the passwords of the password generation units 72 and 76 to the measurement instrument 60 at a desired time. For example, it is preferable for the timing adjustment unit to send the passwords “ABC” of the password generation units 72 and 76 one minute before the scheduled time for the user to reach the measurement instrument 60, and for the display unit 61 to display the password for just two minutes before and after the scheduled time. Thus, because the timing adjustment unit adjusts the timing for displaying the password “ABC”, the password “ABC” is never displayed at unnecessary times, so security can be increased. Therefore, it is possible to perform communication with even higher reliability.

(ii-4) In the apparatuses shown in FIGS. 7, 9, and 10, configurations were presented wherein the password generation units 72 and 76 generate passwords for each operation command from the user control unit 71. However, in cases where operation commands are entered consecutively in the user control unit 71, it is also permissible, within the password validity period based on the first operation command, for the password generation units 72 and 76 to not generate a password, and for the judgment means 73 to send the consecutively entered operation commands to the measurement instrument 60.

(ii-5) In the apparatuses shown in FIGS. 7, 9, and 10, configurations were presented wherein the password “ABC” from the computer 70 is entered, and the entered password “ABC” is displayed on the measurement instrument 60 as the password entered in the computer 70. However, in cases where passwords are sent from multiple computers 70, if an operation command from a computer 70 is currently being executed, then even if a password “ABC” from the computer 70 or another computer is entered, it is permissible for the measurement instrument 60 to not display the entered password “ABC” on the display unit 61.

Thus, in cases where the measurement instrument 60 is executing an operation command from a computer 70, even if a password “ABC” from this computer 70 or another computer is entered, this entered password “ABC” will not be displayed on the display unit 61. For this reason, the operation command which is being executed will not be canceled or changed, even when operated by multiple computers 70. Accordingly, erroneous operations are reduced. Therefore, it is possible to perform communication with higher reliability.

(ii-6) In the apparatus shown in FIG. 9, a configuration was presented wherein the conversion unit 74 converts the password “ABC” from the password generation unit 72 to the password “BCD” and outputs it to the judgment unit. However, it is also permissible for the conversion unit 74 to perform conversion based on the type of operation command entered into the user control unit 71. It is preferable for the conversion unit 74 to change the password “ABC” only in the case of, for example, an operation command for changing the initial settings of the measurement instrument 60, an important operation command, or the like.

(ii-7) In the apparatus shown in FIG. 9, a configuration was presented wherein the conversion unit 74 converts the password “ABC” from the password generation unit 72 to the password “BCD” and outputs it to the judgment unit. However, it is also permissible to provide the conversion unit 74 between the user control unit 71 and judgment means 73. In this case, when the password “ABC” on the display unit 61 is displayed, the user enters the password “ZAB” in the user control unit 71. Next, the conversion unit 74 converts the password “ZAB” from the user control unit 71 to the password “ABC” and outputs it to the judgment means 73.

(ii-8) In the apparatuses shown in FIGS. 4 and 6, configurations were presented wherein an LED 44 is used as the display means. However, it is also permissible to use a 7-segment display LED unit using multiple LEDs, or a liquid crystal display or the like to display letters, numbers and the like. In addition, as in the measurement systems shown in FIGS. 7, 9, and 10, it is preferable to provide at least a user control unit 71, password generation units 72 and 76, and judgment means 73 in the address setting computer 30. Thus, when an IP address is changed, if the password “ABC” from the password generation unit 72 matches the password “ABC” from the user control unit 71, then it is preferable for the judgment means 73 to send the grouped data (IP address and MAC address) to the measurement instruments M1 through M3.

For example, in FIG. 5, the passwords from the password generation units 72 and 76 are displayed in step S205. In addition, between steps S105 and S106, it is preferable for the judgment means 73 to judge whether the password entered by the user in the user control unit matches the password from the password generation units 72 and 76, and to execute step S106 if they match.

The present invention, presented in “(i) Network address setting” and “(ii) Operating measurement instruments”, has merits such as the following.

If the network address setting request from the setting apparatus is addressed to the local equipment, the setting means sets the network address based on the judgment results of the judgment means. More specifically, when the sending/receiving means has established a connection-oriented connection with an external apparatus or setting apparatus, the setting means does not set the network address; if a connection-oriented connection has not been established, the setting means sets the network address. Thus the network address of a measurement instrument engaged in a connection-oriented connection is not changed. Accordingly, a connection-oriented connection between a measurement instrument and an external apparatus or setting apparatus will never be disconnected. Therefore, it is possible to make network address settings while maintaining highly reliable communication.

In addition, when a network address setting request is received, this reception is displayed by the display means, so the user can visually check the measurement instrument being set even if multiple measurement instruments are connected to the network. Accordingly, the user can prevent network addresses from being set on the wrong subject.

In addition, because the collection means causes the sending/receiving means to collect equipment information on the measurement instruments connected to the network, it is possible to check the most recent statuses for the network to which the measurement instruments are connected. Accordingly, it is possible to reliably manage and set network addresses.

In addition, because the address storage means stores the network addresses to be set with respect to measurement instruments, and the sending/receiving means sends all network addresses stored in the address storage means to the measurement instruments, the user does not need to select the measurement instruments one unit at a time and set the network addresses. Accordingly, it is possible to rapidly set network addresses on the measurement instruments.

In addition, the measurement instruments judge whether the sending/receiving means is communicating in a connection-oriented connection with an external apparatus or the aforementioned setting means through the network, and make network address settings based on the judgment results, so the network address of a measurement instrument engaged in a connection-oriented connection is not changed. Accordingly, a connection-oriented connection between a measurement instrument and an external apparatus or setting means will never be disconnected. Therefore, it is possible to make network address settings while maintaining highly reliable communication.

In addition, when an operation command is entered into the user control unit, the password generation unit generates a password and causes the display unit of the measurement instrument to display the password. Next, if the password from the password generation unit matches the password from the user control unit, the judgment unit sends the operation command to the measurement instrument. Thus it is not necessary to cause the measurement instrument to check user IDs or passwords, or to provide a switch in the measurement instrument. Accordingly, security is high and erroneous operations are reduced with simple operations. Therefore, it is possible to perform highly reliable communication even though complex operations are not performed. Furthermore, it is not necessary to provide a switch or memory in the measurement instrument, making it possible to reduce size and cost.

In addition, because the judgment unit checks whether the passwords match within a validity period, security can be increased. Therefore, it is possible to perform more highly reliable communication.

In addition, because the display period is set to the password validity period at the longest, the display unit never displays the password at unnecessary times, so security can be increased. Therefore, it is possible to perform communication with higher reliability.

In addition, because the conversion unit converts the password and the judgment unit judges whether the converted password matches the password from the user control unit, it is possible to operate the measurement instrument only if the conversion rule is matched. Accordingly, security can be increased. Therefore, it is possible to perform communication with higher reliability.

In addition, because the timing adjustment unit adjusts the timing for displaying the password, the password is never displayed at unnecessary times, so security can be increased. Therefore, it is possible to perform communication with higher reliability.

In addition, because the password generation unit generates a password based on the history stored in the history storage unit when an operation command is entered in the user control unit, it is possible to restrict the number of times an operation command can be executed. Accordingly, it is possible to prevent changes to the measurement instrument settings, and to increase the reliability of information set in the measurement instrument.

In addition, while the measurement instrument is executing an operation command from a control apparatus, even if a password from this control apparatus or a different control apparatus is entered, the display unit will not display the entered password. For this reason, the operation command which is being executed will not be canceled or changed, even when operated by multiple control apparatuses. Accordingly, erroneous operations are reduced. Therefore, it is possible to perform communication with higher reliability.

In addition, when an operation command is entered, a password is generated and the display unit on the measurement instrument is caused to display the password. If the generated password matches the password which is entered following the display, then the judgment unit sends the operation command to the measurement instrument. Thus it is not necessary to cause the measurement instrument to check user IDs or passwords, or to provide a switch in the measurement instrument. Accordingly, security is high and erroneous operations are reduced with simple operations. Therefore, it is possible to perform highly reliable communication even though complex operations are not performed. Furthermore, it is not necessary to provide a switch or memory in the measurement instrument, making it possible to reduce size and cost.

What is claimed is:

1. A measurement system comprising measurement instruments which perform measurements in accordance with operation commands sent from a control apparatus through a network, wherein said control apparatus comprises:
a user control unit, into which said operation commands and passwords are entered;
a password generation unit which generates a password when an operation command is entered in this user control unit; and
a judgment unit which sends said operation command to said measurement instrument when said password entered in said user control unit matches said password from said password generation unit;
wherein said measurement instruments comprise a display unit, which inputs said password from said password generation unit, and displays said entered password as said password entered in said user control unit.

2. The measurement system of claim 1, wherein said judgment unit performs judgment within the password validity period of said password generation unit.

3. The measurement system of claim 2, wherein said display unit displays said password from said password generation unit for said validity period at the longest.

4. The measurement system of any one of claims 1 to 3 wherein said password generation unit generates a password for each operation command from said user control unit.

5. The measurement system of any one of claims 1 to 3 wherein said control apparatus comprises a conversion unit which converts at least said password entered in said user control unit or said password from said password generation unit according to prescribed rules and outputs it to said judgment unit.

6. The measurement system of claim 5 wherein said conversion unit performs conversion according to the type of operation command entered in said user control unit.

7. The measurement system of any one of claims 1 to 3 wherein said control apparatus comprises a timing adjustment unit which adjusts the timing for sending, to said measurement instrument, said password generated by said password generation unit.

8. The measurement system of any one of claims 1 to 3 wherein said judgment unit includes a history storage unit which stores the history of transmitted commands sent from said measurement instruments, wherein said password generation unit generates passwords based on said history stored in said history storage unit.

9. The measurement system of any one of claims 1 to 3 wherein while an operation command from said control apparatus is being executed, said display unit will not display passwords from said control apparatus or other control apparatuses.
